(19) United States
(12) Patent Application Publication
(10) Pub. No.: US 2026/0091546 A1
(43) Pub. Date: Apr. 2, 2026

(54) SINGLE SIDED CARBONIZATION TOOLING FOR OPF DERIVED C/C

(71) Applicant: GOODRICH CORPORATION, Charlotte, NC (US)

(72) Inventors: Kyle Rosenbrock, Pueblo, CO (US); Marc A. Guerrero, Pueblo West, CO (US)

(73) Assignee: GOODRICH CORPORATION, Charlotte, NC (US)

(21) Appl. No.: 19/299,220

(22) Filed: Aug. 13, 2025

Related U.S. Application Data
(60) Provisional application No. 63/701,285, filed on Sep. 30, 2024.

(51) Int. Cl. B29C 51/18; B29C 51/00; B29C 51/42; B29K 633/20

(52) U.S. Cl. CPC B29C 51/18; B29C 51/004; B29C 51/421; B29K 2633/20; B29K 2907/04

(57) ABSTRACT

A shape forming tool for carbonization of a fibrous preform is provided, comprising a single sided mold. A fibrous preform may be shaped around the mold by lateral weights coupled to and compressed toward the mold.

### CROSS REFERENCE TO RELATED APPLICATIONS

This application claims priority to and the benefit of U.S. Provisional Patent Application No. 63/701,285, entitled “SINGLE SIDED CARBONIZATION TOOLING FOR OPF DERIVED C/C,” filed on Sep. 30, 2024, which is hereby incorporated by reference in its entirety for all purposes.

### FIELD

The present disclosure relates to carbon/carbon composites, and more specifically, to systems and methods for manufacturing carbon/carbon (C/C) composites.

### BACKGROUND

Composite bodies are utilized in various industries, including the aerospace industry. C/C composites are often produced as 2D structures, for example utilizing planar oxidized polyacrylonitrile (PAN) fiber-based preforms followed by carbonization and chemical vapor infiltration (CVI) densification. Typically, one or more layers of a composite material are stacked together in a flat, planar configuration. These flat layers can undergo various pre-forming processing (e.g., needling, etc.). The preform is then typically moved to a mold for forming the preform into a desired shape. In the case of C/C (carbon/carbon) composites, the shaped preform is then typically moved to one or more other fixtures as it goes through carbonization and chemical vapor infiltration (CVI) densification processes. Tool material and handling can be expensive.

### SUMMARY

According to various embodiments, single sided carbonization tooling systems and methods are disclosed. In various embodiments, the present disclosure provides for a single sided carbonization tooling system which may comprise a shaping feature. In various embodiments, the single sided carbonization tooling system may comprise a first slot disposed on the shaping feature. In various embodiments, the single sided carbonization tooling system may comprise a first arm coupled to the shaping feature. In various embodiments, the single sided carbonization tooling system may comprise a second arm coupled to the shaping feature. In various embodiments, the single sided carbonization tooling system may comprise a first lateral weight proximate the first arm. In various embodiments, the single sided carbonization tooling system may comprise a second lateral weight proximate the second arm. In various embodiments, the single sided carbonization tooling system may comprise a fibrous preform. In various embodiments, the single sided carbonization tooling system may comprise a first point located at a first contact surface between the first lateral weight and the fibrous preform at a first point in time. In various embodiments, the single sided carbonization tooling system may comprise a second point located at the first contact surface at a second point in time. In various embodiments, the single sided carbonization tooling system may comprise a first compression path located between the first point and the second point. In various embodiments, the first slot may be parallel to the first compression path.

In various embodiments, the fibrous preform of the single sided carbonization tooling system may be an oxidized polyacrylonitrile (PAN) fiber-based preform. In various embodiments, the shaping feature of the single sided carbonization tooling system may be a graphite die.

In various embodiments, the fibrous preform of the single sided carbonization tooling system may be compressed between the first arm and the first lateral weight and compressed between the second arm and the second lateral weight.

In various embodiments, the first point may represent a location of the first lateral weight in contact with and perpendicular to the first contact surface of the fibrous preform at the first point in time. In various embodiments, the second point may represent a location of the first lateral weight in contact with and perpendicular to the first contact surface of the fibrous preform at the second point in time.

In various embodiments, the single sided carbonization tooling system may comprise a first bar coupling the first lateral weight to the shaping feature via the first slot.

In various embodiments, the single sided carbonization tooling system may comprise a second slot disposed on the shaping feature. In various embodiments, the single sided carbonization tooling system may comprise a third point locating a second contact surface between the second lateral weight and the fibrous preform at the first point in time. In various embodiments, the single sided carbonization tooling system may comprise a fourth point locating the second contact surface at the second point in time. In various embodiments, the single sided carbonization tooling system may comprise a second compression path located between the third point and the fourth point. In various embodiments, the second slot may be parallel to the second compression path.

In various embodiments, the third point may represent a location of the second lateral weight in contact with and perpendicular to the second contact surface of the fibrous preform at the first point in time. In various embodiments, the fourth point may represent a location of the second lateral weight in contact with and perpendicular to the second contact surface of the fibrous preform at the second point in time.

In various embodiments, the single sided carbonization tooling system may comprise a second bar coupling the second lateral weight to the shaping feature via the second slot.

In various embodiments, the present disclosure provides for a single sided carbonization tooling system which may comprise a shaping feature. In various embodiments, the single sided carbonization tooling system may comprise a first arm coupled to the shaping feature. In various embodiments, the single sided carbonization tooling system may comprise a second arm coupled to the shaping feature. In various embodiments, the single sided carbonization tooling system may comprise a first lateral weight proximate the first arm. In various embodiments, the single sided carbonization tooling system may comprise a second lateral weight proximate the second arm. In various embodiments, the single sided carbonization tooling system may comprise a first slot disposed on the first lateral weight. In various embodiments, the single sided carbonization tooling system may comprise a fibrous preform. In various embodiments, the single sided carbonization tooling system may comprise a first point locating a first contact surface between the first lateral weight and the fibrous preform at a first point in time. In various embodiments, the single sided carbonization tooling system may comprise a second point locating the first contact surface at a second point in time. In various embodiments, the single sided carbonization tooling system may comprise a first compression path located between the first point and the second point. In various embodiments, the first slot is parallel to the first compression path.

In various embodiments, the fibrous preform may be an oxidized polyacrylonitrile (PAN) fiber-based preform. In various embodiments, the shaping feature may be a graphite die.

In various embodiments, the single sided carbonization tooling system may comprise a proximate end of the first lateral weight. In various embodiments, the single sided carbonization tooling system may comprise a slot distal end of the first lateral weight. In various embodiments, the single sided carbonization tooling system may comprise a center of gravity of the first lateral weight located between the proximate end of the first lateral weight and the slot distal end of the first lateral weight.

In various embodiments, the single sided carbonization tooling system may comprise a proximate end of the second lateral weight. In various embodiments, the single sided carbonization tooling system may comprise a slot distal end of the second lateral weight. In various embodiments, the single sided carbonization tooling system may comprise a center of gravity of the second lateral weight located between the proximate end of the second lateral weight and the slot distal end of the second lateral weight.

In various embodiments, the first point may represent a location of the first lateral weight in contact with and perpendicular to the first contact surface of the fibrous preform at the first point in time. In various embodiments, the second point may represent a location of the first lateral weight in contact with and perpendicular to the first contact surface of the fibrous preform at the second point in time.

In various embodiments, the single sided carbonization tooling system may comprise a first bar coupling the first lateral weight to the shaping feature via the first slot.

In various embodiments, the single sided carbonization tooling system may comprise a second slot disposed on the second lateral weight. In various embodiments, the single sided carbonization tooling system may comprise a third point locating a second contact surface between the second lateral weight and the fibrous preform at the first point in time. In various embodiments, the single sided carbonization tooling system may comprise a fourth point locating the second contact surface at the second point in time. In various embodiments, the single sided carbonization tooling system may comprise a second compression path located between the third point and the fourth point. In various embodiments, the second slot is parallel to the second compression path.

In various embodiments, the third point may represent a location of the second lateral weight in contact with and perpendicular to the second contact surface of the fibrous preform at the first point in time. In various embodiments, the fourth point may represent a location of the second lateral weight in contact with and perpendicular to the second contact surface of the fibrous preform at the second point in time.

In various embodiments, the single sided carbonization tooling system may comprise a second bar coupling the second lateral weight to the shaping feature via the second slot.

In various embodiments, the present disclosure provides for a method for manufacturing a C/C part, the method. In various embodiments, the method for manufacturing a C/C part may comprise arranging a fibrous preform over a shaping feature. In various embodiments, the method for manufacturing a C/C part may comprise arranging the fibrous preform between a first lateral weight and a first arm coupled to the shaping feature. In various embodiments, the method for manufacturing a C/C part may comprise arranging the fibrous preform between a second lateral weight and a second arm of the shaping feature. In various embodiments, the method for manufacturing a C/C part may comprise identifying a first point locating a first contact surface between the first lateral weight and the fibrous preform at a first point in time. In various embodiments, the method for manufacturing a C/C part may comprise identifying a second point locating the first contact surface at a second point in time. In various embodiments, the method for manufacturing a C/C part may comprise identifying a first compression path located between the first point and the second point. In various embodiments, the method for manufacturing a C/C part may comprise locating a first slot in at least one of the shaping feature or the first lateral weight, the first slot being parallel to the first compression path. In various embodiments, the method for manufacturing a C/C part may comprise coupling the first lateral weight to the shaping feature via the first slot. In various embodiments, the method for manufacturing a C/C part may comprise heating the fibrous preform.

In various embodiments, the method for manufacturing a C/C part may comprise identifying a third point locating a second contact surface between second lateral weight and the fibrous preform at the first point in time. In various embodiments, the method for manufacturing a C/C part may comprise identifying a fourth point locating the second contact surface at the second point in time. In various embodiments, the method for manufacturing a C/C part may comprise identifying a second compression path located between the third point and the fourth point. In various embodiments, the method for manufacturing a C/C part may comprise locating a second slot in at least one of the shaping feature or the second lateral weight, the second slot being parallel to the first compression path. In various embodiments, the method for manufacturing a C/C part may comprise coupling the first lateral weight to the shaping feature via the second slot.

In various embodiments, the fibrous preform may be an oxidized polyacrylonitrile (PAN) fiber-based preform, and wherein the shaping feature may be a graphite die.

### BRIEF DESCRIPTION OF THE DRAWINGS

FIG. 1 illustrates a fibrous preform, in accordance with various embodiments;

FIG. 2 illustrates a single sided carbonization tool, in accordance with various embodiments;

FIG. 3 illustrates a single sided carbonization tool, in accordance with various embodiments;

FIG. 4a illustrates an axial view of a preform arranged into a single sided carbonization tool, in accordance with various embodiments;

FIG. 4b illustrates a lateral view of a preform arranged into a single sided carbonization tool, in accordance with various embodiments;

FIG. 5a illustrates a sectional view of a preform arranged into a single sided carbonization tool, in accordance with various embodiments;

FIG. 5b illustrates a sectional view of a preform arranged into a single sided carbonization tool, in accordance with various embodiments;

FIG. 6 illustrates a shaped body, in accordance with various embodiments;

FIG. 7 illustrates compression paths of a single sided carbonization tool, in accordance with various embodiments;

FIG. 8 illustrates a center of gravity of lateral weights, in accordance with various embodiments;

FIG. 9 illustrates a method of forming a C/C part, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “fiber volume ratio” means the ratio of the volume of the fibers of the fibrous preform to the total volume of the fibrous preform. For example, a fiber volume ratio of 25% means the volume of the fibers in the fibrous preform is 25% of the total volume of fibrous preform.

As used herein, the term “fiber density” is used with its common technical meaning with units of g/cm3 or g/cc. The fiber density may refer specifically to that of the individual fibers in the fibrous preform. The density will be measured, unless otherwise noted, by taking the weight divided by the geometric volume of each fiber. The density may refer to an average density of a plurality of fibers included in a fibrous preform.

As used herein, “CVI/CVD” may refer to chemical vapor infiltration and/or chemical vapor deposition. Accordingly, CVI/CVD may refer to chemical vapor infiltration or deposition or both.

As used herein, the terms “tow” and “cable” are used to refer to one or more strands of substantially continuous filaments. Thus, a “tow” or “cable” may refer to a plurality of strands of substantially continuous filaments or a single strand of substantially continuous filament.

As used herein, the unit “K” represents “thousand.” Thus, a 1K tow means a tow comprising about 1,000 strands of substantially continuous filaments. For example, a “heavy tow” may comprise about 48,000 (48K) textile fibers in a single tow, whereas a “medium tow” may comprise about 24,000 (24K) textile fibers within a single tow whereas a “lighter tow” may comprise about 6,000 (6K) textile fibers within a single tow. Fewer or greater amounts of textile fibers may be used per cable in various embodiments. In various embodiments disclosed herein, starting carbon fiber tows in accordance with various embodiments may comprise tows of from about 0.1K to about 100K, and, in various embodiments, heavier tows.

In general, there are currently two primary methods of manufacturing carbon/carbon (“C/C”) materials. The first method involves the layup and cure of a carbon fiber, phenolic resin matrix composite, followed by pyrolysis and subsequent phenolic resin infiltration and pyrolysis cycles. Multiple resin infiltration, cure, and pyrolysis cycles are typically used until the part achieves the desired density. The second method involves fabrication of an oxidized polyacrylonitrile fiber (OPF), or carbon fiber preform, followed by carbonization (for OPF preforms) and chemical vapor infiltration (CVI) densification.

C/C material is generally formed by utilizing either continuous oxidized polyacrylonitrile (PAN) fibers, referred to as “OPF” fibers or carbonized carbon fibers, referred to herein as carbon fibers. Such fibers are used to fabricate a preform shape using a needle punching process. OPF fibers or carbon fibers are layered in a selected orientation into a preform of a selected geometry. Two or more layers of fibers are layered onto a support and are then needled together simultaneously or in a series of needling steps. This process interconnects the horizontal fibers with a third direction (also called the z-direction). The fibers extending into the third direction are also called z-fibers. This needling process may involve driving a multitude of barbed needles into the fibrous layers to displace a portion of the horizontal fibers into the z-direction. Carbonization/graphitization may be conducted in a vacuum or partial vacuum (e.g., at pressures of 1 millitorr to 15 torr, at pressures of 1-10 millitorr, at pressures of 1-15 torr) or in an inert atmosphere at a temperature in the range from about 1,200° C. to about 2,800° C. (2,192° F. to about 5,072° F.), and in various embodiments in the range from about 1,600° C. to about 2,200° C. (2,912° F. to about 3,992° F.), and in various embodiments in the range from about 1,600° C. to about 2,500° C. (2,912° F. to about 4,532° F.) (wherein the term about in this context only means+/−100° C.) for a period of time in the range of up to about 60 hours, and in various embodiments, in the range up to about 10 hours (wherein the term about in this context only means+/−2 hours). The resulting preform generally has the same fibrous structure as the fibrous preform before carbonizing. However, the OPF have been converted to 100% carbon or very near 100%, for example from 95% carbon to 99.9% carbon. The resulting preform may be referred to as having a fibrous network. In various embodiments, the carbonization process imparts high temperature dimensional stability to the final C/C part. In various embodiments, the carbonization process imparts desired thermal properties associated with thermal shock such as high thermal conductivity, high heat capacity, and/or high emissivity.

A third method may involve a combination of the two aforementioned processes including layup and cure of a carbon fiber, phenolic resin matrix composite, followed by pyrolysis, and CVI densification.

C/C parts of the present disclosure are formed using OPF fabrics that are shape-formed prior to carbonization. C/C parts of the present disclosure may be formed using multi-axial, non-crimp, stitch-bonded, OPF fabrics that are shape-formed prior to carbonization. C/C parts of the present disclosure may be particularly useful for high temperature aerospace applications, such as for re-entry vehicle applications or other high temperature applications such as where a hot gas impinges on the vehicle after being rapidly compressed and heated. C/C parts of the present disclosure may be especially useful in these applications because of the superior high temperature characteristics of C/C material. In particular, the carbon/carbon material used in C/C parts is a good conductor of heat and is able to dissipate heat generated during high temperature conditions. Carbon/carbon material is also highly resistant to heat damage, and thus, may be capable of sustaining forces during severe conditions without mechanical failure.

Application of OPF-based carbon-carbon composites has been generally limited to simple flat structures including C/C aircraft brake disks. C/C components including leading edges, structural members and other contour-shape carbon composites are often produced as 2D structures (i.e., flat, planar components); however, these materials tend to maintain low interlaminar properties. A shape formed 3D C/C part offers opportunity for similar in-plane C/C properties with higher interlaminar properties than 2D C/C.

The material and material handling required for tooling C/C components can be expensive. Therefore, systems and methods of forming C/C components with a single sided mold (such as a mold with only a bottom die), rather than multi-sided molds (such as molds with a top die and a bottom die or multiple dies), are preferred in order to save material and tooling costs. The systems and methods herein relate to single sided molds and tooling for C/C components.

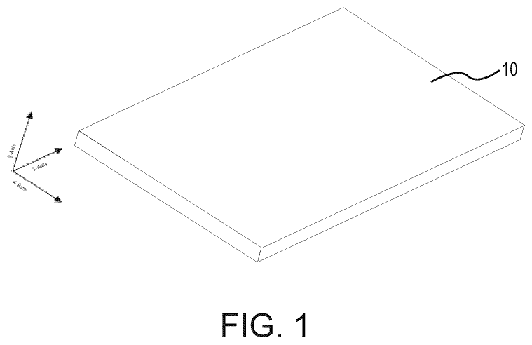

With reference to FIG. 1, a fibrous preform 10 is illustrated. The fibrous preform 10 may comprise polyacrylonitrile (PAN) or OPF fibers extending in multiple (i.e. at least three) directions and leaving a plurality of pores or open spaces and may be prepared for shape-forming, compression, and carbonization. In various embodiments, fibrous preform 10 is formed by stacking layers of PAN or OPF fibers and superimposing the layers. The layers may be needled perpendicularly to each other (i.e., along the Z-direction) with barbed, textile needles or barbless, structuring needles. In various embodiments, the layers are needled at an angle of between 0° and 89° (e.g., 0°, 30°, 45°, 60°, and/or 89°) with respect to the Z-direction in order to be needled to each other. The needling process generates a series of z-fibers through fibrous preform 10 that extend perpendicularly to the fibrous layers and in the Z-direction. The z-fibers are generated through the action of the needles pushing fibers from within the layer (x-y or in-plane) and reorienting them in the Z-direction, (through-thickness). Needling of the fibrous preform 10 may be done as one or more layers are added to the stack or may be done after the entire stack of layers is formed. The needles may also penetrate through only a portion of the fibrous preform 10. or may penetrate through the entire fibrous preform 10. In addition, resins are added, in various embodiments, to fibrous preform 10 by either injecting the resin into the preform following construction or coating the fibers or layers prior to forming the fibrous preform 10. The needling process may take into account needling parameters optimized to maintain fiber orientation, minimize in-plane fiber damage, and maintain target interlaminar properties.

After needling the fibrous preform 10, the non-woven fibrous preform 10 may be both compressed to higher fiber volume ratio and formed to shape in a single-step shape-forming process (i.e., using the shape forming tool system of the present disclosure). It should be understood, moreover, that a fibrous preform 10 not subject to needling prior to pre-carbonization compression are also within the scope of the present disclosure.

The carbonization process may be employed to convert the fibers of the fibrous preform 10 into pure carbon fibers, as used herein only “pure carbon fibers” means carbon fibers comprised of at least 99% carbon. The carbonization process is distinguished from the densification process described below in that the densification process involves infiltrating the pores of the fibrous preform 10 and depositing a carbon matrix within and around the carbon fibers of the fibrous preform 10, and the carbonization process refers to the process of converting the fibers of the fibrous preform 10 into pure carbon fibers.

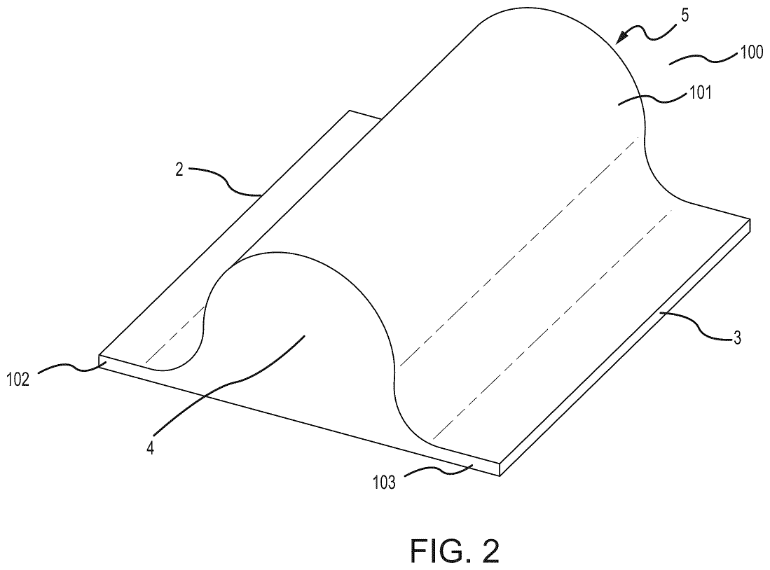

With reference to FIG. 2, a single sided carbonization tool 100 is provided. Single sided carbonization tool 100 may comprise a first side 2. Single sided carbonization tool 100 may comprise a second side 3. Single sided carbonization tool 100 may comprise a first end 4. Single sided carbonization tool 100 may comprise a second end 5.

In various embodiments, single sided carbonization tool 100 may comprise a shaping feature 101. Shaping feature 101 may be carbon tooling. Shaping feature 101 may be a graphite die. Shaping feature 101 may have a geometry of a desired C/C component. Shaping feature 101 may extend from the first end 4 to the second end 5. Shaping feature 101 may comprise a uniform geometry from the first end 4 to the second end 5. Shaping feature 101 may comprise a non-uniform or complex geometry from the first end 4 to the second end 5. For example, shaping feature 101 may have a rounded cross section. For example, shaping feature 101 may have a semi-circle cross section. For example, shaping feature 101 may have a non-uniform cross section.

In various embodiments, single sided carbonization tool 100 may comprise a first arm 102. Single sided carbonization tool 100 may comprise a second arm 103. First arm 102 may extend laterally along a first side 2 from the first end 4 to the second end 5. In various embodiments, single sided carbonization tool 100 may comprise a second arm 103. Single sided carbonization tool 100 may comprise a second arm 103. Second arm 103 may extend laterally along a second side 3 from the first end 4 to the second end 5. First arm 102 and second arm 103 may be carbon tooling. First arm 102 and second arm 103 may comprise graphite.

In various embodiments, first arm 102 may be coupled to shaping feature 101. First arm 102 may be coupled to shaping feature 101 such that first arm 102 extends beyond the geometry of a desired C/C component. In various embodiments, second arm 103 may be coupled to shaping feature 101. Second arm 103 may be coupled to shaping feature 101 such that second arm 103 extends beyond the geometry of a desired C/C component.

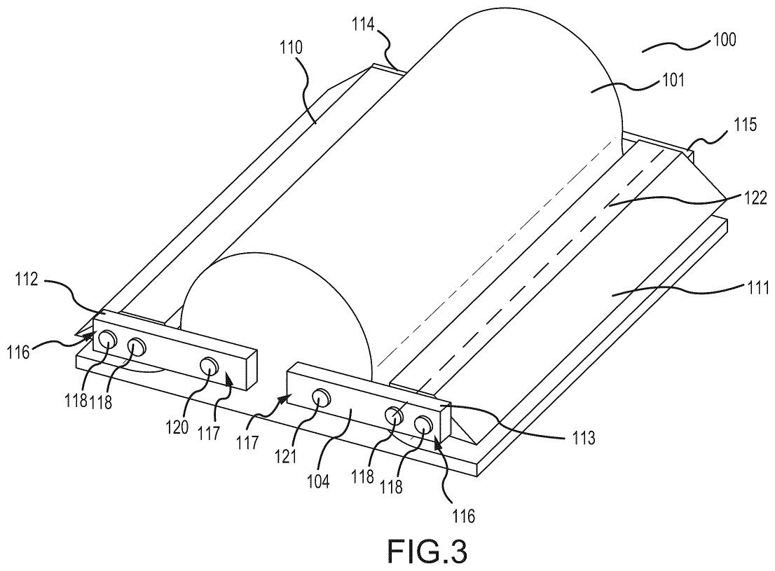

With reference to FIG. 3, single sided carbonization tool 100 may comprise a first lateral weight 110. First lateral weight 110 may be located proximate to first arm 102. First lateral weight 110 may be located beyond the geometry of a desired C/C component. In various embodiments, single sided carbonization tool 100 may comprise a second lateral weight 111. Second lateral weight 111 may be located proximate to second arm 103. Second lateral weight 111 may be located beyond the geometry of a desired C/C component. First lateral weight 110 and second lateral weight 111 may extend laterally along a first side 2 from the first end 4 to the second end 5.

With continued reference to FIG. 3, single sided carbonization tool 100 may comprise a first bar 112. Single sided carbonization tool 100 may comprise a second bar 113. Single sided carbonization tool 100 may comprise a third bar 114. Single sided carbonization tool 100 may comprise a fourth bar 115. First bar 112 may couple the first lateral weight 110 to the shaping feature 101 at the first end 4. Second bar 113 may couple the second lateral weight 111 to the shaping feature 101 at the first end 4. Third bar 114 may couple the first lateral weight 110 to the shaping feature 101 at the second end 5. Fourth bar 115 may couple the second lateral weight 111 to the shaping feature 101 at the second end 5.

In various embodiments, each of the first bar 112, second bar 113, third bar 114, and fourth bar 115 comprises a fixed end 116 and a sliding end 117. The fixed end 116 is coupled with a fixed fastener 118. For example, the fixed end 116 of the first bar 112 may be coupled to, for example, the first lateral weight 110 via a screw, a bolt, welding, or any means which prevents the fixed end 116 from translating relative to the first lateral weight 110. In various embodiments, the sliding end 117 is coupled through a first slot 120 or a second slot 121 (explained in further detail below). For example, the sliding end 117 of, for example, the second bar 113 may be coupled to such that the sliding end 117 may translate relative the shaping feature 101 via a first slot 120 or a second slot 121 such that the second bar 113 may translate relative to a first slot 120 or a second slot 121.

For example, a rod 122 may be located through first lateral weight 110 and secured to first bar 112 and third bar 114. For example, a rod 122 may be located through first lateral weight 110 and secured to first bar 112 and third bar 114. For example, two rods 122 may be located through first lateral weight 110 and secured to first bar 112 and third bar 114. For example, a rod 122 may be located through second lateral weight 111 and secured to second bar 113 and fourth bar 115. For example, two rods 122 may be located through second lateral weight 111 and secured to second bar 113 and fourth bar 115. For example, a rod (or multiple rods) 122 may be located through shaping feature 101 and secured to first bar 112 and second bar 113. For example, a rod (or multiple rods) 122 may be located through shaping feature 101 and secured to second bar 113 and fourth bar 115.

In various embodiments, the fixed end 116 of each of the first bar 112, second bar 113, third bar 114, and fourth bar 115 may be coupled to the shaping feature 101. In various embodiments, the fixed end 116 of each of the first bar 112, second bar 113, third bar 114, and fourth bar 115 may be coupled to either the first lateral weight 110 or the second lateral weight 111). Each of the bars (the first bar 112, second bar 113, third bar 114, and fourth bar 115) may be coupled uniformly.

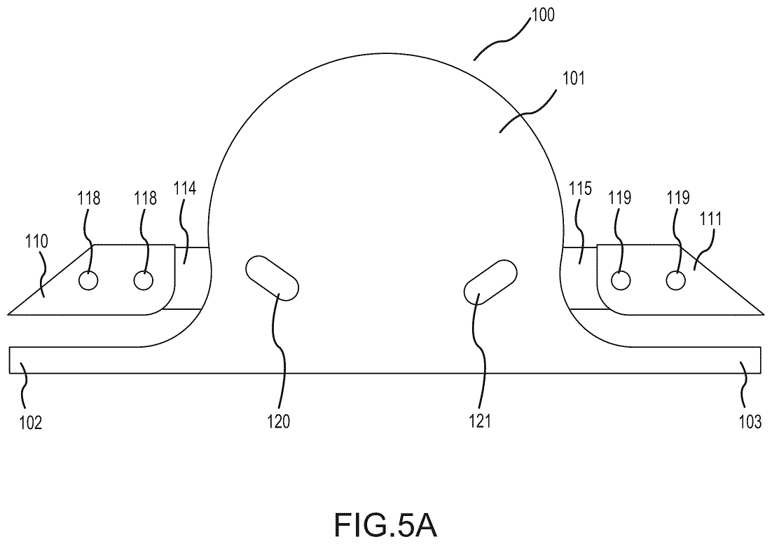

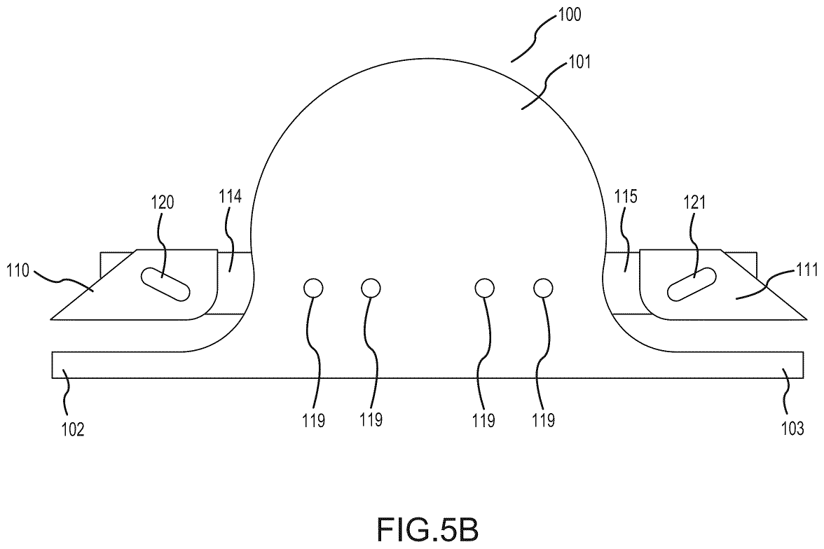

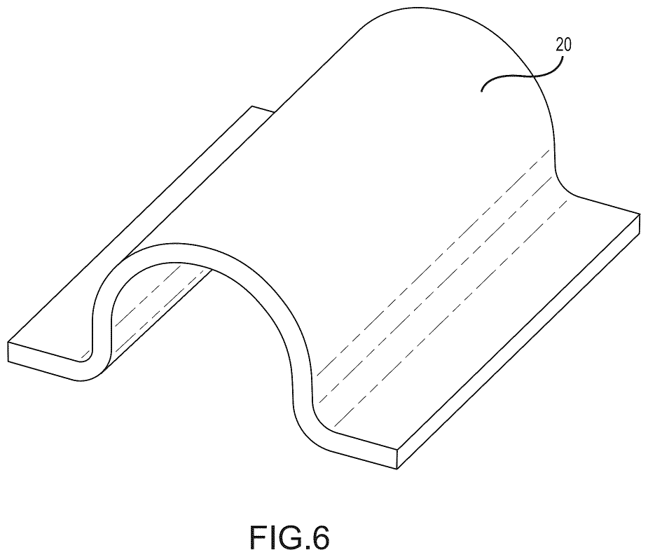

In other words, in various embodiments and as depicted in FIGS. 3 and 5a, the fixed end 116 of first bar 112 may be coupled to the first lateral weight 110. As such, the fixed end 116 of the second bar 113 is coupled to the second lateral weight 111, the fixed end 116 of the third bar 114 is coupled to the first lateral weight 110, and the fixed end 116 of the fourth bar 115 is coupled to the second lateral weight 111. Further, the sliding ends 117 of each of the first bar 112, second bar 113, third bar 114, and fourth bar 115 may then be coupled to the shaping feature 101.

However, in various embodiments and as depicted in FIG. 5b, the fixed end 116 of first bar 112 may be coupled to the shaping feature 101. As such, the fixed ends 116 of each of the second bar 113, third bar 114, and fourth bar 115 are coupled to the shaping feature 101. Further, the sliding end 117 of the second bar 113 is coupled to the second lateral weight 111, the sliding end 117 of the third bar 114 is coupled to the first lateral weight 110, and the sliding end 117 of the fourth bar 115 is coupled to the second lateral weight 111.

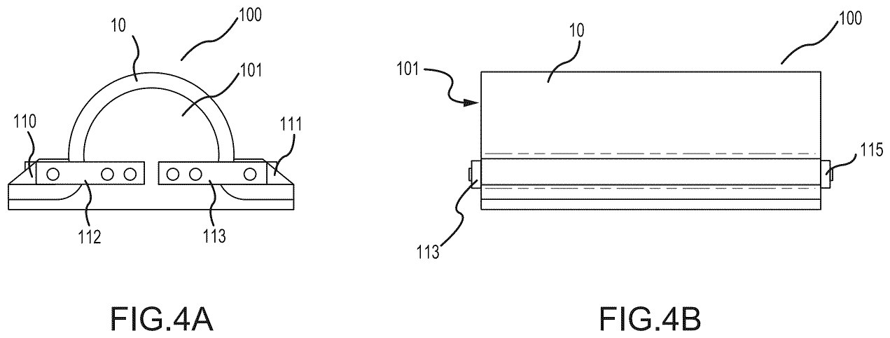

FIGS. 4a and 4b illustrate a fibrous preform 10 loaded into in single sided carbonization tool 100. FIG. 4a depicts a fibrous preform 10 loaded into in single sided carbonization tool 100 from an axial view. FIG. 4b depicts a fibrous preform 10 loaded into in single sided carbonization tool 100 from a lateral view. Fibrous preform 10 may be located over shaping feature 101. Fibrous preform 10 may be located between first arm 102 and first lateral weight 110. Fibrous preform 10 may be located between second arm 103 and second lateral weight 111. Fibrous preform 10 may be arranged between first lateral weight 110 and first arm 102 such that fibrous preform 10 is compressed by gravity between first lateral weight 110 and first arm 102. Fibrous preform 10 may be arranged between second lateral weight 111 and second arm 103 such that fibrous preform 10 is compressed by gravity between second lateral weight 111 and second arm 103.

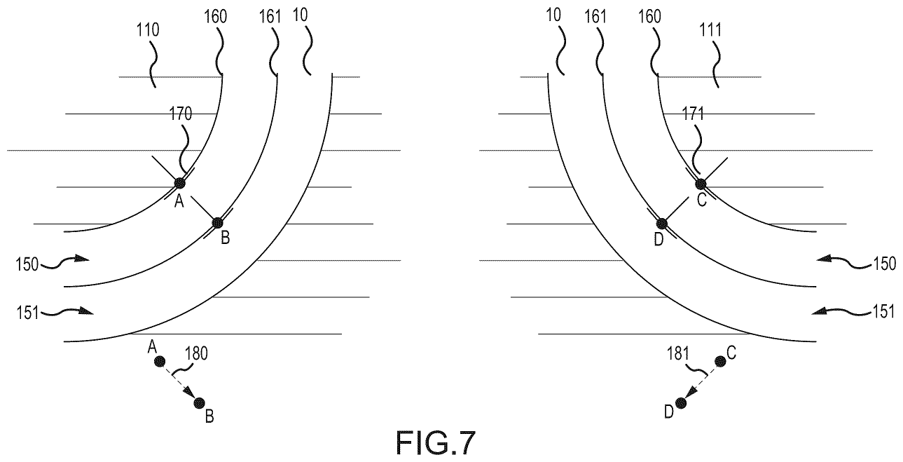

With reference to FIG. 7 and in various embodiments, fibrous preform 10 is located at a first location 150 at a first time 160. First time 160 may represent a time after loading fibrous preform 10 into the single sided carbonization tool 100 but prior to carbonization of fibrous preform 10. In various embodiments, fibrous preform 10 is located at a second location 151 at a second time 161. In various embodiments, second time 161 may represent a time after loading fibrous preform 10 into the single sided carbonization tool 100 and during carbonization of fibrous preform 10. In various embodiments, second time 161 may represent a time after loading fibrous preform 10 into the single sided carbonization tool 100 and after carbonization of fibrous preform 10.

With reference to FIG. 7, single sided carbonization tool 100 may comprise a first point, point A. Point A may be defined at first time 160. Point A may represent a location of first lateral weight 110 in contact with and perpendicular to a first contact surface 170 of fibrous preform 10 at first time 160. Single sided carbonization tool 100 may comprise a second point, point B. Point B may be defined at second time 161. Point B may represent a location of first lateral weight 110 in contact with and perpendicular to a first contact surface 170 of fibrous preform 10 at second time 161. A first compression path 180 may be defined by a vector from point A to point B.

With continued reference to FIG. 7, single sided carbonization tool 100 may comprise a third point, point C. Point C may be defined at first time 160. Point C may represent a location of second lateral weight 111 in contact with and perpendicular to a second contact surface 171 of fibrous preform 10 at first time 160. Single sided carbonization tool 100 may comprise a fourth point, point D. Point D may be defined at second time 161. Point D may represent a location of second lateral weight 111 in contact with and perpendicular to a second contact surface 171 of fibrous preform 10 at second time 161. A second compression path 181 may be defined by a vector from point C to point D.

With reference to FIGS. 5a and 5b, single sided carbonization tool 100 may comprise a first slot 120. In various embodiments, single sided carbonization tool 100 may comprise a second slot 121. First slot 120 may be located proximate first side 2. Second slot 121 may be located proximate second side 3. In various embodiments and as depicted in FIG. 5a, first slot 120 and second slot 121 may be disposed on shaping feature 101. In various embodiments and as depicted in FIG. 5b, first slot 120 may be disposed on first lateral weight 110. In various embodiments and as depicted in FIG. 5b, second slot 121 may be disposed on second lateral weight 111.

In various embodiments, first slot 120 may be located such that first slot 120 is parallel to first compression path 180. First slot 120 may be designed such that, in response to thermal expansion, first slot 120 causes first lateral weight 110 to translate along first compression path 180. First slot 120 may be designed such that, in response to compression of the fibrous preform 10, first slot 120 causes the first lateral weight 110 to translate along first compression path 180. In various embodiments, second slot 121 may be located such that second slot 121 is parallel to second compression path 181. Second slot 121 may be designed such that, in response to thermal expansion second slot 121 causes second lateral weight 111 to translate along second compression path 181. Second slot 121 may be designed such that, in response to compression of the fibrous preform 10, second slot 121 causes second lateral weight 111 to translate along second compression path 181.

Translation of the first lateral weight 110 along the first compression path 180 and/or translation of the second lateral weight 111 along the second compression path 181 reduces or eliminates slipping of the fibrous preform 10 while loaded in single sided carbonization tool 100. Further, translation of the first lateral weight 110 along the first compression path 180 and/or translation of the second lateral weight 111 along the second compression path 181 ensures fibrous preform 10 conforms to the contours of shaping feature 101 during carbonization.

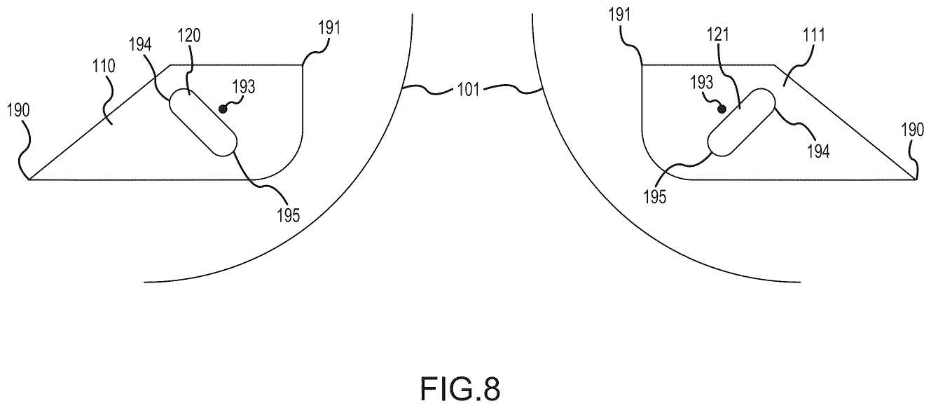

With respect to FIG. 8, a position of a center of gravity 193 of each of the first lateral weight 110 and the second lateral weight 111 is provided. Each lateral weight (110 and 111) may have a distal end 190 and a proximate end 191. Distal end 190 may be further from shaping feature 101 than proximate end 191. In other words, proximate end 191 may be closer to shaping feature 101 than distal end 190. In various embodiments, first lateral weight 110 may comprise a first slot 120 and second lateral weight 111 may comprise a second slot 121. First slot 120 and second slot 121 may each comprise a slot distal end 194 and a slot proximate end 195. Slot distal end 194 may be further from shaping feature 101 than slot proximate end 195. In other words, slot proximate end 195 may be closer to shaping feature 101 than slot distal end 194.

A center of gravity 193 of first lateral weight 110 may be located between distal end 190 and proximate end 191. A center of gravity 193 of first lateral weight 110 may be located between slot distal end 194 and proximate end 191. A center of gravity 193 of first lateral weight 110 may be located between slot proximate end 195 and proximate end 191.

A center of gravity 193 of second lateral weight 111 may be located between distal end 190 and proximate end 191. A center of gravity 193 of second lateral weight 111 may be located between slot distal end 194 and proximate end 191. A center of gravity 193 of second lateral weight 111 may be located between slot proximate end 195 and proximate end 191.

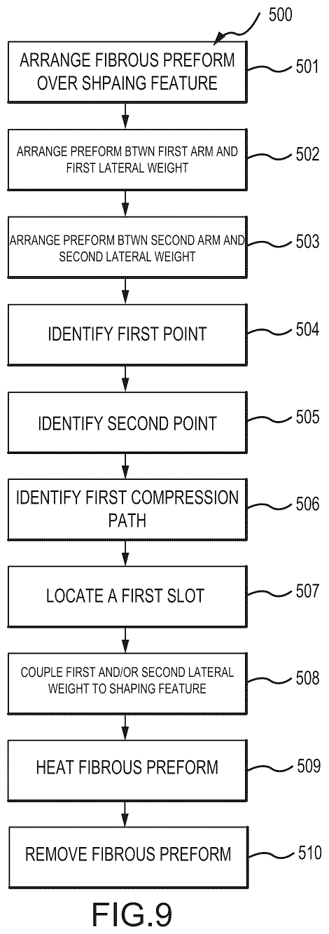

With respect to FIG. 9, a method 500 for manufacturing a C/C part is provided.

In step 501, a fibrous preform 10 may be arranged with a single sided carbonization tool 100. Fibrous preform 10 may be arranged over shaping feature 101. Prior to the arranging of the fibrous preform 10 with the single sided carbonization tool 100, fibrous preform 10 may undergo needling, as described above.

In step 502, fibrous preform 10 may be arranged between first lateral weight 110 and first arm 102 such that fibrous preform 10 is compressed by gravity between first lateral weight 110 and first arm 102. In various embodiments, first lateral weight 110 is arranged such that center of gravity 193 of first lateral weight 110 may be located between distal end 190 and proximate end 191. Center of gravity 193 of first lateral weight 110 may be located between slot distal end 194 and proximate end 191. Center of gravity 193 of first lateral weight 110 may be located between slot proximate end 195 and proximate end 191.

In step 503, fibrous preform 10 may be arranged between second lateral weight 111 and second arm 103 such that fibrous preform 10 is compressed by gravity between second lateral weight 111 and second arm 103. In various embodiments, second lateral weight 111 is arranged such that the center of gravity 193 of second lateral weight 111 may be located between distal end 190 and proximate end 191. Center of gravity 193 of second lateral weight 111 may be located between slot distal end 194 and proximate end 191. Center of gravity 193 of second lateral weight 111 may be located between slot proximate end 195 and proximate end 191.

In step 504, a first point, point A, may be identified. First point (point A) may be defined at first time 160. Point A represents a location of first lateral weight 110 in contact with and perpendicular to a first contact surface 170 of fibrous preform 10 at first time 160.

In step 505, a second point, point B, may be identified. Point B may be defined at second time 161. Point B represents a location of first lateral weight 110 in contact with and perpendicular to a first contact surface 170 of fibrous preform 10 at second time 161.

In various embodiments, step 504 or step 505 may include a third point, point C. Point C may be defined at first time 160. Point C may represent a location of second lateral weight 111 in contact with and perpendicular to a second contact surface 171 of fibrous preform 10 at first time 160.

In various embodiments, step 504 or step 505 may include a fourth point, point D. Point D may be defined at second time 161. Point D may represent a location of second lateral weight 111 in contact with and perpendicular to a second contact surface 171 of fibrous preform 10 at second time 161.

In step 506, first compression path 180, as described above, may be identified. In various embodiments, step 506 may comprise identifying second compression path 181, as described above.

In step 507, a first slot 120 may be located, as described above, to translate first lateral weight 110 along a first compression path 180. First slot 120 may be located on shaping feature 101. First slot 120 may be located on first lateral weight 110. In various embodiments, in step 507, a second slot 121 may be located, as described above, to translate second lateral weight 111 along a second compression path 181. Second slot 121 may be located on shaping feature 101. Second slot 121 may be located on second lateral weight 111.

In step 508, first lateral weight 110 may be coupled to shaping feature 101 via at least one of first bar 112 and third bar 114, as described above. For example, in various embodiments first bar 112 and third bar 114 may be coupled via a fixed end 116 to first lateral weight 110 and via a sliding end 117 to shaping feature 101. In various embodiments, first bar 112 and third bar 114 may be coupled via a sliding end 117 to first lateral weight 110 and via a fixed end 116 to shaping feature 101.

In various embodiments step 508 may also comprise coupling second lateral weight 111 to shaping feature 101 via at least one of second bar 113 and fourth bar 115, as described above. For example, in various embodiments, second bar 113 and fourth bar 115 may be coupled via a fixed end 116 to second lateral weight 111 and via a sliding end 117 to shaping feature 101. For example, in various embodiments, second bar 113 and fourth bar 115 may be coupled via a sliding end 117 to second lateral weight 111 and via a fixed end 116 to shaping feature 101.

In step 509, fibrous preform 10 may undergo a carbonization process during which fibrous preform 10 may be heated. Carbonization process 506 may be conducted in a furnace. Carbonization process may be conducted as described above.

In step 509, the fibrous preform 10 may be condensed (e.g. shrunk) to conform to the contours of the shaping feature 101. Through shrinking and conforming to the shaping feature 101, the fibrous preform 10 is formed into shaped body 20.

Method 500 may comprise a step 510, in which shaped body 20 may be removed from the single sided carbonization tool 100. Shaped body 20 may be removed by un-coupling at least one of first bar 112, second bar 113, third bar 114, and fourth bar 115 to release shaped body 20 from single sided carbonization tool 100. In various embodiments, step 510 comprises cooling the shaped body 20 prior to removal.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A single sided carbonization tooling system, comprising:
a shaping feature;
a first slot disposed on the shaping feature;
a first arm coupled to the shaping feature;
a second arm coupled to the shaping feature;
a first lateral weight proximate the first arm;
a second lateral weight proximate the second arm;
a fibrous preform;
a first point located at a first contact surface between the first lateral weight and the fibrous preform at a first point in time;
a second point located at the first contact surface at a second point in time; and
a first compression path located between the first point and the second point, wherein the first slot is parallel to the first compression path.

2. The single sided carbonization tooling system of claim 1, wherein the fibrous preform is an oxidized polyacrylonitrile (PAN) fiber-based preform, and wherein the shaping feature is a graphite die.

3. The single sided carbonization tooling system of claim 1, wherein the fibrous preform is compressed between the first arm and the first lateral weight and compressed between the second arm and the second lateral weight.

4. The single sided carbonization tooling system of claim 1, wherein the first point represents a location of the first lateral weight in contact with and perpendicular to the first contact surface of the fibrous preform at the first point in time, and wherein the second point represents a location of the first lateral weight in contact with and perpendicular to the first contact surface of the fibrous preform at the second point in time.

5. The single sided carbonization tooling system of claim 4, further comprising a first bar coupling the first lateral weight to the shaping feature via the first slot.

6. The single sided carbonization tooling system of claim 5, further comprising:
a second slot disposed on the shaping feature;
a third point locating a second contact surface between the second lateral weight and the fibrous preform at the first point in time;
a fourth point locating the second contact surface at the second point in time; and
a second compression path located between the third point and the fourth point, wherein the second slot is parallel to the second compression path.

7. The single sided carbonization tooling system of claim 6, wherein the third point represents a location of the second lateral weight in contact with and perpendicular to the second contact surface of the fibrous preform at the first point in time, and wherein the fourth point represents a location of the second lateral weight in contact with and perpendicular to the second contact surface of the fibrous preform at the second point in time.

8. The single sided carbonization tooling system of claim 7, further comprising a second bar coupling the second lateral weight to the shaping feature via the second slot.

9. A single sided carbonization tooling system, comprising:
a shaping feature;
a first arm coupled to the shaping feature;
a second arm coupled to the shaping feature;
a first lateral weight proximate the first arm;
a second lateral weight proximate the second arm;
a first slot disposed on the first lateral weight;
a fibrous preform;
a first point locating a first contact surface between the first lateral weight and the fibrous preform at a first point in time;
a second point locating the first contact surface at a second point in time; and
a first compression path located between the first point and the second point, wherein the first slot is parallel to the first compression path.

10. The single sided carbonization tooling system of claim 9, wherein the fibrous preform is an oxidized polyacrylonitrile (PAN) fiber-based preform, and wherein the shaping feature is a graphite die.

11. The single sided carbonization tooling system of claim 9, further comprising:
a proximate end of the first lateral weight;
a slot distal end of the first lateral weight; and
a center of gravity of the first lateral weight located between the proximate end of the first lateral weight and the slot distal end of the first lateral weight.

12. The single sided carbonization tooling system of claim 11, further comprising:
a proximate end of the second lateral weight;
a slot distal end of the second lateral weight; and
a center of gravity of the second lateral weight located between the proximate end of the second lateral weight and the slot distal end of the second lateral weight.

13. The single sided carbonization tooling system of claim 9, wherein the first point represents a location of the first lateral weight in contact with and perpendicular to the first contact surface of the fibrous preform at the first point in time, and wherein the second point represents a location of the first lateral weight in contact with and perpendicular to the first contact surface of the fibrous preform at the second point in time.

14. The single sided carbonization tooling system of claim 13, further comprising a first bar coupling the first lateral weight to the shaping feature via the first slot.

15. The single sided carbonization tooling system of claim 14, further comprising:
a second slot disposed on the second lateral weight;
a third point locating a second contact surface between the second lateral weight and the fibrous preform at the first point in time;
a fourth point locating the second contact surface at the second point in time; and
a second compression path located between the third point and the fourth point, wherein the second slot is parallel to the second compression path.

16. The single sided carbonization tooling system of claim 15, wherein the third point represents a location of the second lateral weight in contact with and perpendicular to the second contact surface of the fibrous preform at the first point in time, and wherein the fourth point represents a location of the second lateral weight in contact with and perpendicular to the second contact surface of the fibrous preform at the second point in time.

17. The single sided carbonization tooling system of claim 16, further comprising a second bar coupling the second lateral weight to the shaping feature via the second slot.

18. A method for manufacturing a C/C part, the method comprising:
arranging a fibrous preform over a shaping feature;
arranging the fibrous preform between a first lateral weight and a first arm coupled to the shaping feature;
arranging the fibrous preform between a second lateral weight and a second arm of the shaping feature;
identifying a first point locating a first contact surface between the first lateral weight and the fibrous preform at a first point in time;
identifying a second point locating the first contact surface at a second point in time;
identifying a first compression path located between the first point and the second point;
locating a first slot in at least one of the shaping feature or the first lateral weight, the first slot being parallel to the first compression path;
coupling the first lateral weight to the shaping feature via the first slot; and
heating the fibrous preform.

19. The method of claim 18, further comprising:
identifying a third point locating a second contact surface between second lateral weight and the fibrous preform at the first point in time;
identifying a fourth point locating the second contact surface at the second point in time;
identifying a second compression path located between the third point and the fourth point;
locating a second slot in at least one of the shaping feature or the second lateral weight, the second slot being parallel to the first compression path; and
coupling the first lateral weight to the shaping feature via the second slot.

20. The method of claim 18, wherein the fibrous preform is an oxidized polyacrylonitrile (PAN) fiber-based preform, and wherein the shaping feature is a graphite die.
